(19) United States
(12) Patent Application Publication
(10) Pub. No.: US 2014/0107827 A1
(43) Pub. Date: Apr. 17, 2014

(54) Method for Designing and Making Jewelry

(71) Applicant: Garrett S. Chalmers, Oregon, WI (US)

(72) Inventor: Garrett S. Chalmers, Oregon, WI (US)

(21) Appl. No.: 13/652,060

(22) Filed: Oct. 15, 2012

(51) Int. Cl. G06F 17/50; G06F 19/00

(52) U.S. Cl. 700/118; 703/1

(57) ABSTRACT

The present disclosure relates to methods for designing and making custom jewelry. In various exemplary embodiments, a surface of the jewelry piece is designed using a two-dimensional image, such as a scanned fingerprint, photograph, or words. The two-dimensional image is digitized (e.g., converted into a set of lines in a CAD program) then converted into a three-dimensional image. The three-dimensional shape is then incorporated into a surface of the jewelry (e.g., the image is “cut” into the surface of the jewelry piece design).

### BACKGROUND

1. Field of the Invention

The present disclosure relates to the design and manufacture of custom jewelry.

2. Related Art

Jewelry continues to play a significant role in society, particularly in interpersonal relationships. Giving jewelry made of precious metals and gemstones is an important symbol of love or appreciation. Typically, jewelry is produced by casting the metal and then adding gemstones, if any. In a typical casting process, a positive cast or prototype of the piece is formed of wax. A negative cast or mold is then formed around the prototype, which is subsequently removed from the cast by melting and draining the wax. Molten metal is poured into the mold and cooled to form the piece.

In the art of custom jewelry design, messages, designs, or other images are sometimes engraved into a surface of the jewelry. For example, a message and/or date may be inscribed on the surface of a ring. Also for example, fingerprint patterns are sometimes engraved on jewelry pieces. Conventional methods require a craftsman to painstakingly engrave the image on the subject. However, this is an expensive and sometimes inaccurate process. For example, the replication of a pattern or design, such as a fingerprint, is inherently imprecise creating an inaccurate replica of the design. In some cases, the design may be engraved using machine tools, but such methods still rely upon inaccurate replicas of a pattern such as a fingerprint. Engraving methods also make only a shallow impression, which can wear off over time (e.g., if on the inside surface of a ring).

### SUMMARY

An exemplary embodiment relates to a method for designing a piece of jewelry comprising providing a digital image, preparing a two-dimensional line drawing version of the digital image, converting the two-dimensional lines to three-dimensional shapes, adapting the three-dimensional shape to match a selected surface of a selected piece of jewelry, overlaying the three-dimensional shape on the selected surface of the selected piece of jewelry such that the three-dimensional shape overlaps with the piece of jewelry, and removing the three-dimensional image and deleting the area of overlap from the piece of jewelry.

Another exemplary embodiment relates to a method for designing a piece of jewelry comprising scanning an object to create a two-dimensional image, preparing a two-dimensional line drawing version of the image, converting the two-dimensional lines to three-dimensional shapes, adapting the three-dimensional shape to match a selected surface of a selected piece of jewelry, overlaying the three-dimensional shape on the selected surface of the selected piece of jewelry such that the three-dimensional shape overlaps with the piece of jewelry, and removing the three-dimensional image and deleting the area of overlap from the piece of jewelry.

Another exemplary embodiment relates to a method for designing and making a piece of jewelry comprising providing a digitized image, preparing a two-dimensional line drawing version of the digitized image, converting the two-dimensional lines to three-dimensional shapes, adapting the three-dimensional shape to match a selected surface of a selected piece of jewelry, overlaying the three-dimensional shape on the selected surface of the selected piece of jewelry such that the three-dimensional shape overlaps with the piece of jewelry, removing the three-dimensional image and deleting the area of overlap from the piece of jewelry, forming a model of the jewelry piece, investing the model and removing the model from the investment, and casting the jewelry piece using the investment.

These and other features and advantages of various embodiments of systems and methods according to this invention are described in, or are apparent from, the following detailed description of various exemplary embodiments of various devices, structures, and/or methods according to the present disclosure.

### BRIEF DESCRIPTION OF THE DRAWINGS

Various exemplary embodiments of the systems and methods according to the present disclosure will be described in detail, with reference to the following figures, wherein:

FIG. 1 is a top plan view of a fingerprint being converted to lines according to the present disclosure;

FIG. 2 is top plan view of the fingerprint of FIG. 1 converted to lines according to the present disclosure;

FIG. 3 is a isometric top view of the fingerprint of FIG. 2 converted to a three dimensional shape according to the present disclosure;

FIG. 4 is a isometric top view of the fingerprint of FIG. 3 adapted according to the present disclosure;

FIG. 5 is an isometric side view of the fingerprint of FIG. 4 curved to the shape of and overlaid on as exemplary piece of jewelry according to the present disclosure;

FIG. 6 is an isometric side view of the fingerprint and jewelry of FIG. 4 showing the fingerprint being trimmed to within the confines of the jewelry according to the present disclosure;

FIG. 7 is an isometric side view of the fingerprint and jewelry of FIG. 4 showing; and

FIG. 8 is an isometric side view of an exemplary piece of jewelry according to the present disclosure.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION OF THE EXEMPLARY EMBODIMENTS

The present disclosure relates to a method of designing and making pieces of jewelry. More particularly, it relates to a method of taking any pattern or design and incorporating it into a surface of a piece of jewelry. In various exemplary embodiments, the jewelry piece is first designed digitally. The digital design can there be used to make the jewelry piece. In various exemplar/embodiments, the piece is designed using a computer-aided design (CAD) program such as, for example, Matrix, Rhinoceros, or Monarch.

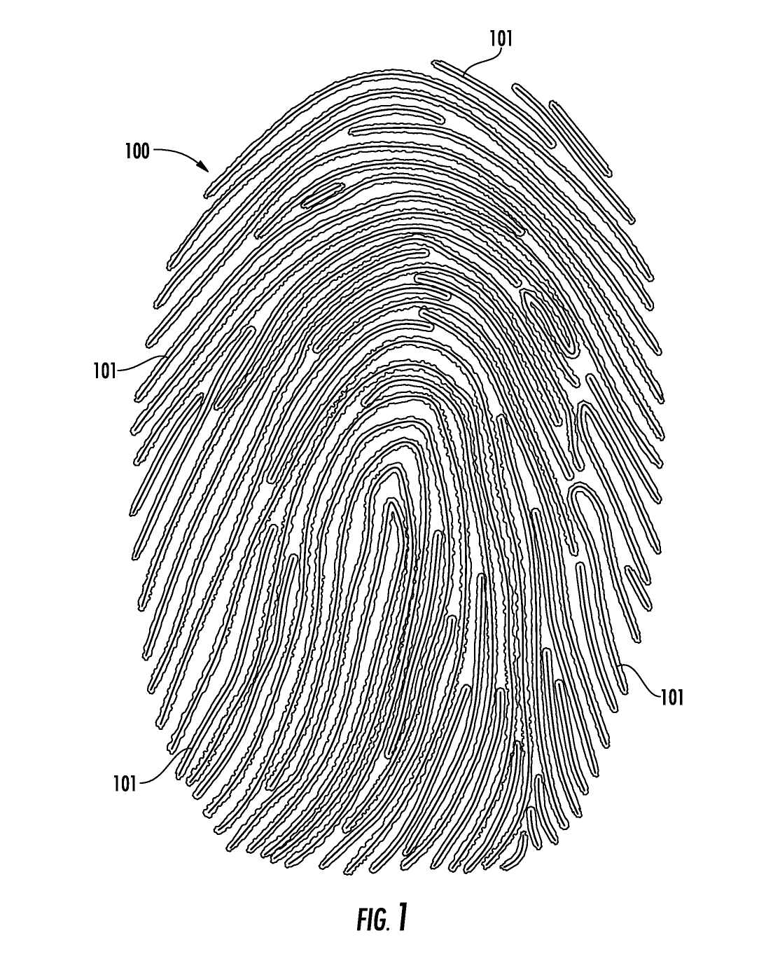

In various exemplary embodiments, as illustrated by FIG. 1, a chosen image is digitized. FIG. 1 shows a scanned fingerprint 100. The fingerprint 100 may be obtained by any appropriate means including fingerprint scanners or taking an ink print and scanning it. As shown in FIG. 1, lines 101 are placed over the fingerprint 100 to create a two-dimensional line copy 110 of the fingerprint 100.

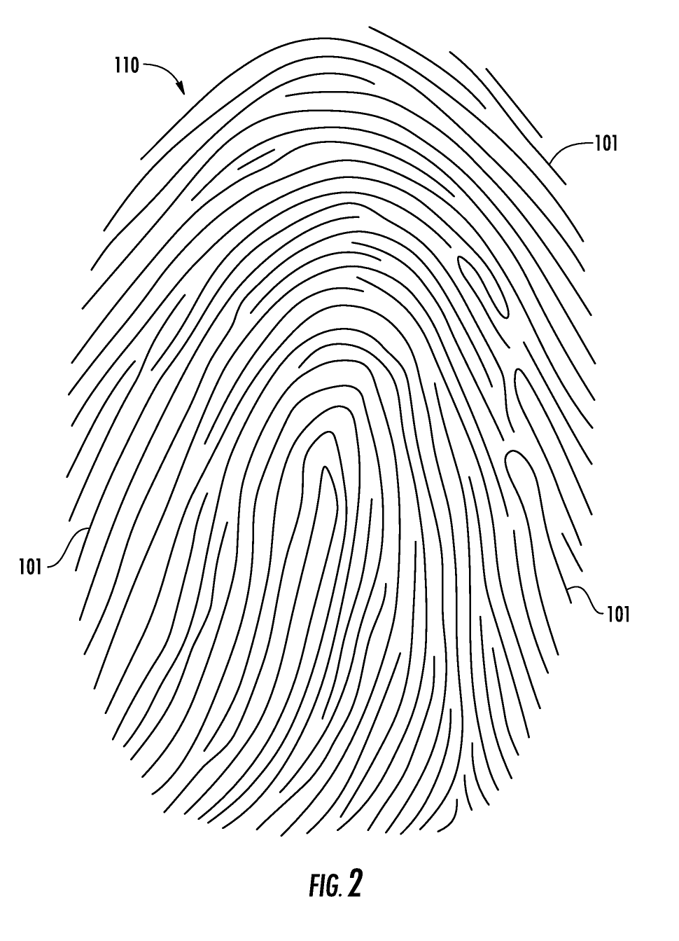

In various exemplary embodiments, an image such as a fingerprint or photograph may be converted in to a two-dimensional line image 110, such as the exemplary image no show in FIG. 2. In various other exemplary embodiments, the process may be started with an existing two-dimensional line drawing. In various exemplary embodiments, the two-dimensional shape comprised of the lines formed as shown in FIGS. 1 and 2 may be scaled to a selected size for the desired piece of jewelry.

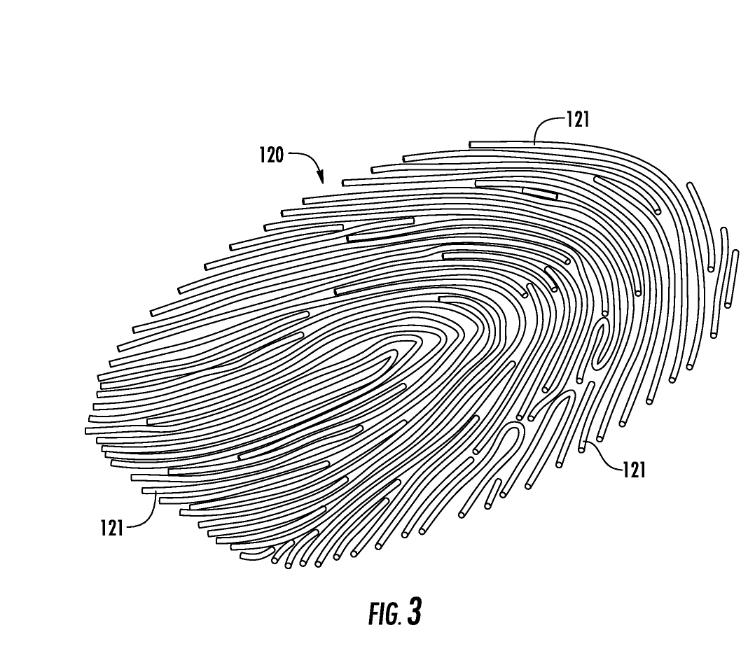

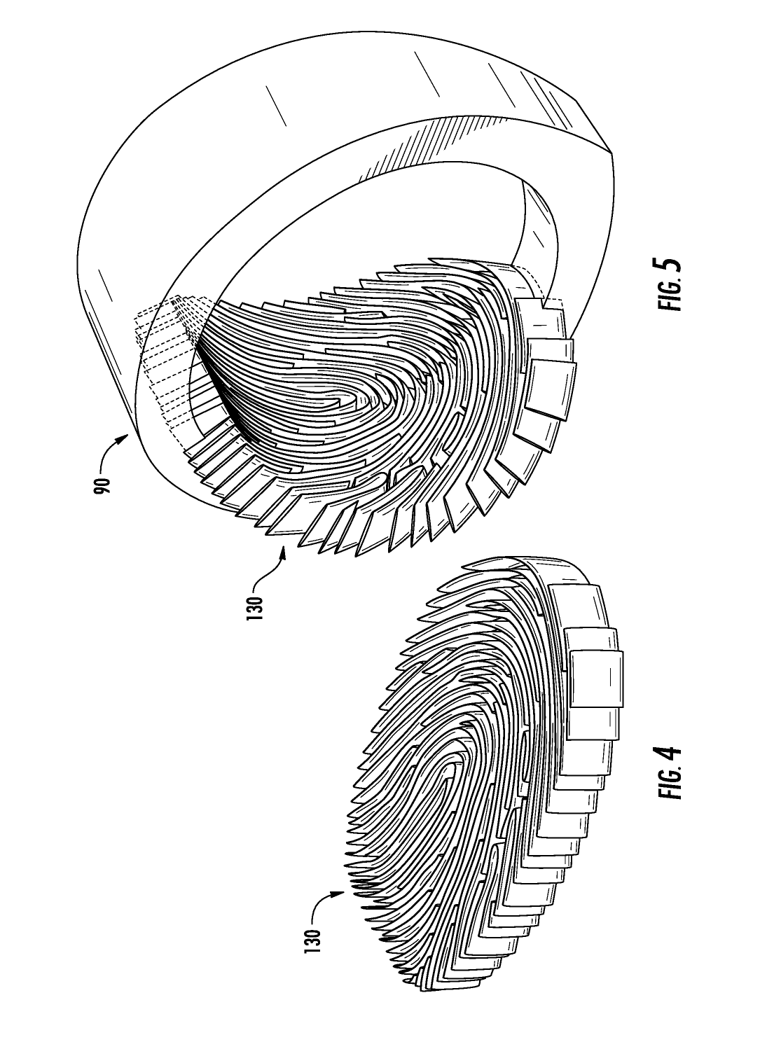

In various exemplary embodiments, the two-dimensional lines 101 are converted to solid tubes 121 creating a three-dimensional image 120, as shown in FIG. 3, A three-dimensional image 120 is preferred because the piece of jewelry to be designed is three dimensional regardless of the surface shape to which the image will be applied. In various exemplary embodiments, the three dimensional image is manipulated to be higher, as shown in FIG. 4.

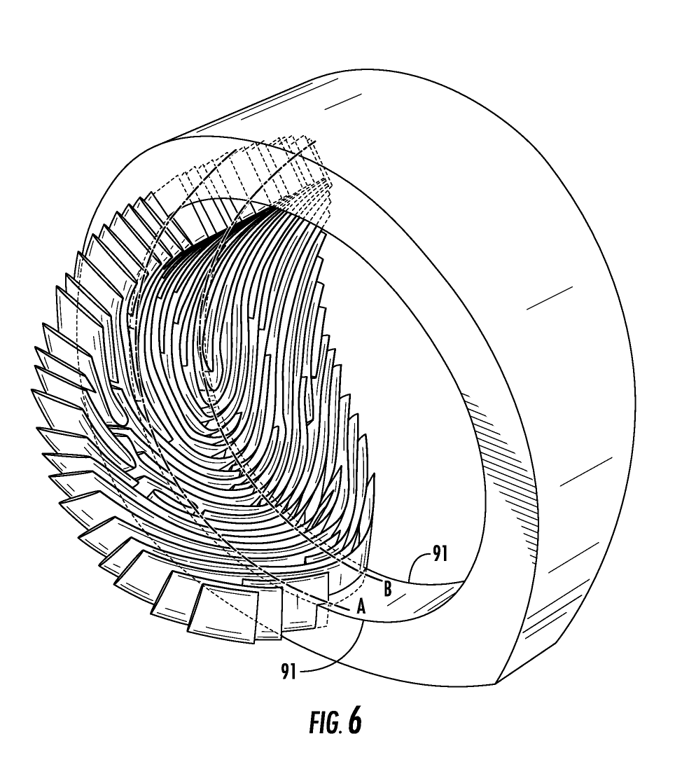

In various exemplary embodiments, an image 120 such as that shown in FIGS. 3 and 4 is manipulated as necessary to fit a selected piece of jewelry 90. Such manipulation may include, for example, scaling the size of the image up or down and increasing the height of the image. In various exemplary embodiments, the adjusted image 130 is overlaid on a surface of a selected piece of jewelry 90, as shown in FIG. 5.

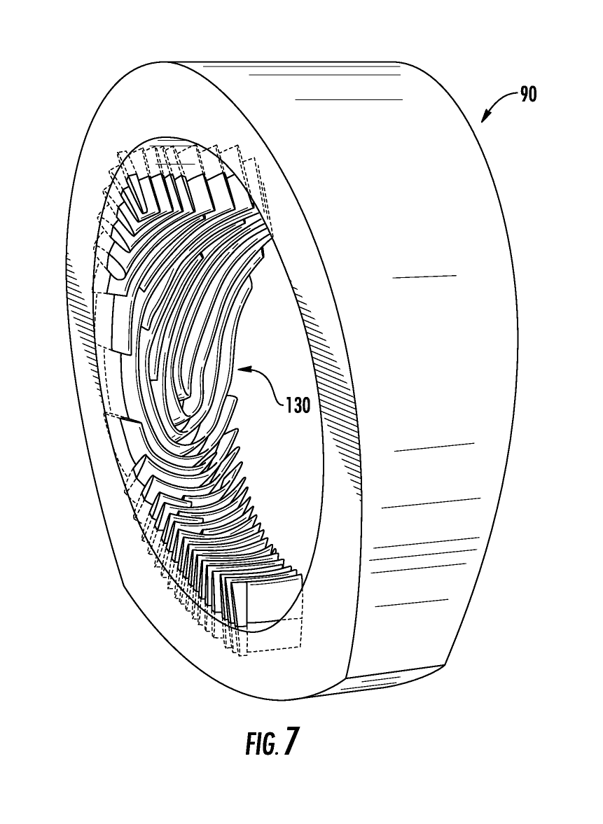

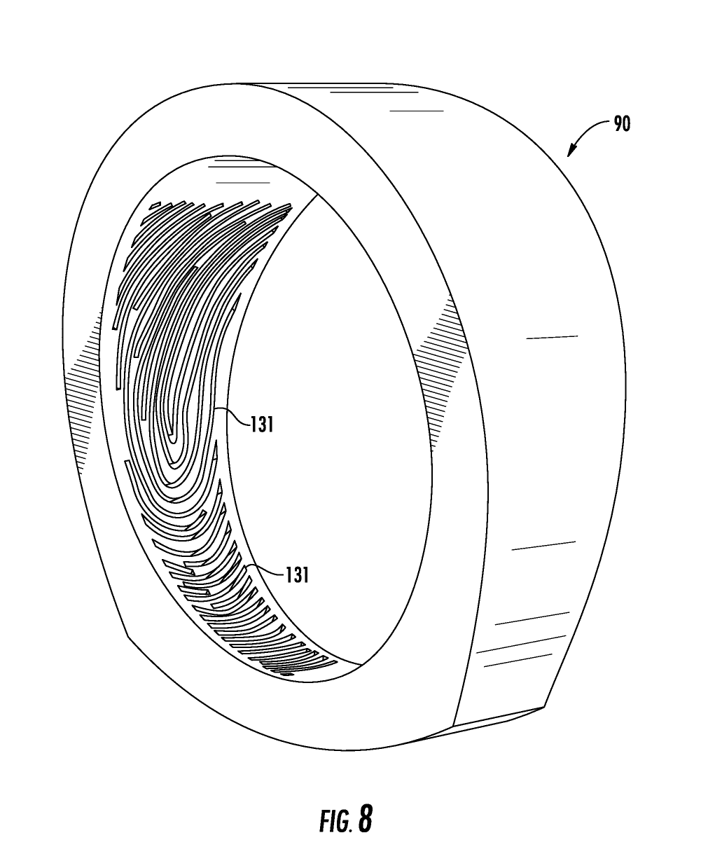

In various exemplary embodiments, as illustrated in FIG. 6, the image 130 overlaid on the jewelry 90 is trimmed to at least the edges 91 of the jewelry piece along lines A and B. In various exemplary embodiments, as shown in FIG. 7, the image 130 is trimmed to a point within the edge of the jewelry piece 90. In various exemplary embodiments, the image 130 functions as a cutter to remove material from the jewelry piece 90 corresponding to the shape of the image 130, as shown in FIG. 8, leaving recesses 131 in the jewelry surface. The design of the piece 90 may now be complete or additional images may be applied using the disclosed method.

In various exemplary embodiments, the jewelry design 90 serves as the basis for making the jewelry piece. Although the jewelry piece 90 may be made using any method now known or later developed, the manufacturing process will be described using investment of wax-loss casting.

In various exemplary embodiments, the digital design is used to make a model or prototype of the jewelry piece, commonly referred to as a wax pattern. Is various exemplary embodiments, the pattern is formed by milling in a wax printer. In various other exemplary embodiments, the pattern is formed using a wax grower. In some preferred embodiments, a wax grower can be used to shape surfaces that cannot be accessed for tooling (e.g., the inner surface of a ring).

In various exemplary embodiments, the wax pattern is sprued (attached to a sprue), preparing it for investing. In various exemplary embodiments, the wax pattern is encased in investment, which is allowed to cure or solidify. In various exemplary embodiments, the wax pattern is removed from the investment by heating it to a liquid and draining it. In various other exemplary embodiments, the wax pattern may be liquefied for removal by other methods such as, for example, chemical dissolution or with a solvent.

In various exemplary embodiments, the investment is used to cast the jewelry piece. Molten metal is introduced into the investment and allowed to cool. The piece is then removed from the investment and is ready for polishing and/or any other additional finishing (e.g., adding gemstones) In various exemplary embodiments, the inset lines may be treated to make them more visible or distinct (e.g., antiquing, black maxing, or colored epoxies).

Although the present disclosure describes the process as used in the manufacture of a ring, it should be noted that the process may be applied to any type of jewelry or other metallic items including, but not limited to, rings, earrings, pendants, lockets, necklaces, bracelets, anklets, cufflinks, knives, and lighters.

Although the present disclosure describes the design process using a fingerprint, it should be noted that the disclosed process may be applied to any shape including, but not limited to, designs, logos, letters and/or numbers, pictures, silhouettes, or any combination thereof.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be appreciated that the construction and arrangement of the design and manufacturing methods, as shown in the various exemplary embodiments, is illustrative only. While the design and manufacturing methods, according to this invention, has been described in conjunction with the exemplary embodiments outlined above, various alternatives, modifications, variations, improvements, and/or substantial equivalents, whether known or that are or may be presently unforeseen, may become apparent. Accordingly, the exemplary embodiments of the design and manufacturing methods, according to this invention, as set forth above, are intended to be illustrative, not limiting. Various changes may be made without departing from the spirit and scope of the invention. Therefore, the description provided above is intended to embrace all known or later-developed alternatives, modifications, variations, improvements, and/or substantial equivalents.

What is claimed is;

1. A method for designing a piece of jewelry comprising:
providing a digital image;
preparing a two-dimensional line drawing version of the digital image;
scaling the two-dimensional image to a selected scale;
converting the two-dimensional lines to three-dimensional shapes;
adapting the three-dimensional shapes to match a selected surface of a selected piece of jewelry;
overlaying the three-dimensional shape on the selected surface of the selected piece of jewelry such that the three-dimensional shape overlaps with the piece of jewelry; and
removing the three-dimensional image and deleting the area of overlap from the piece of jewelry.

2. The method of claim 1 wherein the digital image is a two-dimensional scan of a two- or three-dimensional object.

3. The method of claim 1 wherein the method is performed using computer-aided design.

4. The method of claim 1 wherein the lines in the two-dimensional shape are converted in to three-dimensional tubes.

5. The method, of claim 1 wherein the step of adapting the three-dimensional shapes further comprises manipulating the three-dimensional shape to fit the selected surface.

6. The method of claim 1 further comprising the step of increasing the height of the three-dimensional shape prior to overlapping it on the piece of jewelry.

7. A method for designing a piece of jewelry comprising:
scanning an object to create a two-dimensional image;
preparing a two-dimensional line drawing version of the image;
scaling the two-dimensional image to a selected scale;
converting the two-dimensional lines to three-dimensional shapes;
adapting the three-dimensional shapes to match a selected surface of a selected piece of jewelry;
overlaying the three-dimensional shape on the selected surface of the selected piece of jewelry such that the three-dimensional shape overlaps with the piece of jewelry; and
removing the three-dimensional image and deleting the area of overlap from the piece of jewelry.

8. The method of claim 7 wherein the method is performed using computer-aided design.

9. The method of claim 7 wherein the lines in the two-dimensional shape are converted in to three-dimensional tubes.

10. The method of claim 7 further comprising the step of increasing the height of the three-dimensional shape prior to overlapping it on the piece of jewelry.

11. The method of claim 7 wherein the step of adapting the three-dimensional shapes further comprises manipulating the three-dimensional shape to fit the selected surface.

12. A method for designing and making a piece of jewelry comprising:
providing a digitized image;
preparing a two-dimensional line drawing version of the digitized image;
scaling the two-dimensional image to a selected scale;
converting the two-dimensional lines to three-dimensional shapes;
adapting the three-dimensional shape to match a selected surface of a selected piece of jewelry;
overlaying the three-dimensional shape on the selected surface of the selected piece of jewelry such that the three-dimensional shape overlaps with the piece of jewelry; and
removing the three-dimensional image and deleting the area of overlap from the piece of jewelry;
forming a model of the jewelry piece;
investing the model and removing the model from the investment; and
casting the jewelry piece using the investment.

13. The method of claim 12 wherein the jewelry piece is designed using computer-aided design.

14. The method of claim 12 wherein the lines in the two-dimensional shape are converted into three-dimensional tubes.

15. The method of claim 12 wherein the step of adapting the three-dimensional shapes further comprises manipulating the three-dimensional shape to fit the selected surface.

16. The method of claim 12 further comprising the step of increasing the height of the three-dimensional shape prior to overlapping it on the piece of jewelry.

17. The method of claim 12 wherein the model is removed from the investment by heating and melting the model.

18. The method of claim 12 wherein the model comprises wax.

19. The method of claim 12. wherein the step of forming a model is performed using a wax grower.

20. The method of claim 12 wherein the step of forming a model is performed by machining.
